(19) United States
(12) Patent Application Publication
(10) Pub. No.: US 2019/0244180 A1
(43) Pub. Date: Aug. 8, 2019

(54) NEGOTIATED INSTRUMENTS WITH VERIFIED PAYEE ENDORSEMENT FOR MOBILE DEPOSITS

(71) Applicant: Deluxe Corporation, Shoreview, MN (US)

(72) Inventor: David S. Davies, Ham Lake, MN (US)

(21) Appl. No.: 16/270,446

(22) Filed: Feb. 7, 2019

Related U.S. Application Data
(60) Provisional application No. 62/627,826, filed on Feb. 8, 2018.

(51) Int. Cl. G06Q 20/04; G06Q 40/02; G06K 9/00

(52) U.S. Cl. CPC G06Q 20/0425; G06K 9/00442; G06Q 40/02

(57) ABSTRACT

The present subject matter involves a system and method for providing a check that can be scanned in a way that the information of the check and its endorsements are verified. In various embodiments, the payee endorsement typically found on the reverse side of the check is instead provided on the front of the check allowing the critical information of the check to be scanned in a single image. In various embodiments, the check is marked or encoded with a code, pattern, icon, or other scannable aspect indicating that the check bears substantially all of the critical information on the front of the check. In various embodiments, the placement and nature of a payee endorsement is provided on the front of the check such that it does not interfere with the placement of other information conventionally found on the front of the check. The present subject matter provides an application which can read a mobile deposit endorsement and accept a signature to make mobile deposits of negotiable instruments, such as checks, straightforward and reliable. In some embodiments the method also allows for scanning of conventional checks.

### CLAIM OF PRIORITY

This application claims the benefit of U.S. Provisional Patent Application Ser. No. 62/627,826 filed on Feb. 8, 2019, which is hereby incorporated by reference in its entirety.

### TECHNICAL FIELD

This application relates generally to security features for financial documents and more particularly to the secure processing of negotiable instruments bearing payee endorsements.

### BACKGROUND

Negotiable instruments, including checks, are frequently used by organizations and individuals in financial transactions. Various security features have been incorporated into negotiable instruments for anti-counterfeiting purposes. Because financial fraud employing counterfeiting of documents remains an issue, there is a need to introduce enhanced security features for preventing unauthorized reproduction and alternation of printed negotiable instruments.

One of the difficulties encountered with negotiable instruments employing endorsements occurs when endorsements by the payor and payee cannot be reliably associated with the same negotiable instrument. For example, when a two-sided check is executed on both sides, each side can be electronically scanned; however a fraudster is interested in ways to take advantage of the difficulties of associating both sides of the negotiable instrument as being taken from the same document. Consequently, an inability to unequivocally corroborate signatures from the payor and payee create opportunity for fraudsters to alter the negotiable instrument with a fraudulent endorsement to a payee.

For example, conventional checks have a payor endorsement on the front side and a payee endorsement on the opposite side. When conventional checks are scanned, a commercial establishment may scan both sides with a two-sided scanner, or it may perform two scans using a single-sided scanner. Both methods attempt to associate the front and back side scans with the same check. However, it is difficult to unequivocally associate front and back sides of a scanned check having two independent scan files.

Furthermore, current mobile devices, such as mobile phones and mobile point of sale devices used to attempt mobile check processing do not ensure that the scanned document front and back images are properly associated and cannot verify the signature of the back side of a negotiable instrument reliably and easily.

There is a need in the art for verifying a payee endorsement of a negotiable instrument. There is further a need in the art for making deposits easy to use with mobile devices.

### SUMMARY

In certain various embodiments, the present subject matter involves a system and method for providing a check that can be scanned in a way that the information of the check and its endorsements are verified. In various embodiments, the payee endorsement typically found on the reverse side of the check is instead provided on the front of the check allowing the critical information of the check to be scanned in a single image. In various embodiments, the check is marked or encoded with a code, pattern, icon, or other scannable aspect indicating that the check bears substantially all of the critical information on the front of the check. In various embodiments, the placement and nature of a payee endorsement is provided on the front of the check such that it does not interfere with the placement of other information conventionally found on the front of the check. The present subject matter provides an application which can read a mobile deposit endorsement and accept a signature to make mobile deposits of negotiable instruments, such as checks, straightforward and reliable. In some embodiments the method also allows for scanning of conventional checks that are consistent with conventional check cashing systems and practices, and allows for the payee endorsement on the same side of the check.

In various embodiments, the check is marked or encoded with a code, pattern, icon, or other scannable aspect indicating that the check bears substantially all of the critical information on the front of the check and the placement and nature of a payee endorsement is provided on the front of the check such that it does not interfere with the placement of other information conventionally found on the front of the check. In such embodiments the method allows for scanning of conventional checks that are consistent with conventional check cashing systems and practices, and allows for the payee endorsement on the same side of the check.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF DRAWINGS

FIG. 1A is a front image of a conventional check.

FIG. 1B is a back image of a conventional check.

FIG. 2A is a front image of a negotiable instrument according to one embodiment of the present subject matter.

FIG. 2B is a back image of a negotiable instrument according to one embodiment of the present subject matter.

FIG. 3A is a front image of a negotiable instrument according to various embodiments of the present subject matter.

FIG. 3B is a back image of a negotiable instrument according to various embodiments of the present subject matter.

FIG. 4A is a front image of a check including a mobile endorsement signature according to one embodiment of the present subject matter.

FIG. 4B is a back image of a check including the mobile endorsement signature according to one embodiment of the present subject matter.

FIG. 4C is a back image of a portion of a check including the mobile endorsement signature according to one embodiment of the present subject matter.

FIG. 5A is a front image of a check including a mobile endorsement icon and signature according to one embodiment of the present subject matter.

FIG. 5B is a back image of a check including the mobile endorsement icond and signature according to one embodiment of the present subject matter.

FIG. 6 is a block diagram illustrating one example of a machine, within which a set or sequence of instructions may be executed to cause the machine to perform any one of the methodologies discussed herein, according to one embodiment of the present subject matter.

### DETAILED DESCRIPTION

The following detailed description refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

Bank acceptance of checks for deposit are typically done via brick and mortar banking institutions, remote ATM devices, duplex scanning, flatbed scanning and most recently the camera systems of smart phone and tablet devices. The conversion to electronic form for mobile remote deposit using flatbed scanners and smart phones split the once physical check document into two separate images. The majority of check information is present on the front of a check (Side A). The payee's endorsement on the opposite side of the check is important to know at the point of deposit. Thus, conventional check image processes involve two images. This two-image process makes it difficult to assure that the endorsement on the back side of the check (Image B) is the counterpart image to Side A of the check during the conversion of a paper check to an electronic version of the check.

In certain various embodiments, the present subject matter involves a system and method for providing a check that can be scanned in a way that the information of the check and its endorsements are verified. In various embodiments, the payee endorsement typically found on the reverse side of the check is instead provided on the front of the check allowing the critical information of the check to be scanned in a single image. In various embodiments, the check is marked or encoded with a code, pattern, icon, or other scannable aspect indicating that the check bears substantially all of the critical information on the front of the check. In various embodiments, the placement and nature of a payee endorsement is provided on the front of the check such that it does not interfere with the placement of other information conventionally found on the front of the check. The present subject matter provides an application which can read a mobile deposit endorsement and accept a signature to make mobile deposits of negotiable instruments, such as checks, straightforward and reliable. In some embodiments the method also allows for scanning of conventional checks that are consistent with conventional check cashing systems and practices, and allows for the payee endorsement on the same side of the check.

In various embodiments, the check is marked or encoded with a code, pattern, icon, or other scannable aspect (or combinations thereof) indicating that the check bears substantially all of the critical information on the front of the check, including a payee endorsement. In various embodiments the placement and nature of a payee endorsement is provided on the front of the check such that it does not interfere with the placement of other information conventionally found on the front of the check. In such embodiments the method allows for scanning of conventional checks that are consistent with conventional check cashing systems and practices, and allows for the payee endorsement on the same side of the check.

In various embodiments, a front side payee endorsement is digitally copied from the front side of the negotiable instrument and applied to the reverse side of the negotiable instrument. Such approaches allow for conventional scanning of the new negotiable instrument so as to allow for verification of the payee endorsement whether it is on the front or back side of the negotiable instrument.

In various embodiments the payee endorsement on the back side of a negotiable instrument is copied and printed on the front side of the negotiable instrument. Such approaches allow for a conventional negotiable instrument with two images to be modified as a single image negotiable instrument, and thereby scannable by the system of the present subject matter.

In various embodiments, the scanning of a front side payee endorsement renders scanning of the second side of the check optional. In various embodiments, the scanning process includes both sides of the check so as to be compatible with conventional check scanning. In various embodiments the present subject matter is applied to any negotiable instrument with endorsement information on the reverse side of the instrument, to allow for placement of the information on a single side.

In various embodiments, the negotiable instrument is a bank check. In various embodiments, the negotiable instrument is a personal check. In various embodiments, the negotiable instrument is a cashier's check. In various embodiments, the check has an icon on the front of the check indicating the check bears a payee endorsement on the front of the check. In various embodiments, the location of the icon is used to locate a scannable field for the payee endorsement on the front of the check. In various embodiments, the scannable field for the payee endorsement constitutes at least a part of the icon. Other types of payee endorsements are possible without departing from the scope of the present subject matter.

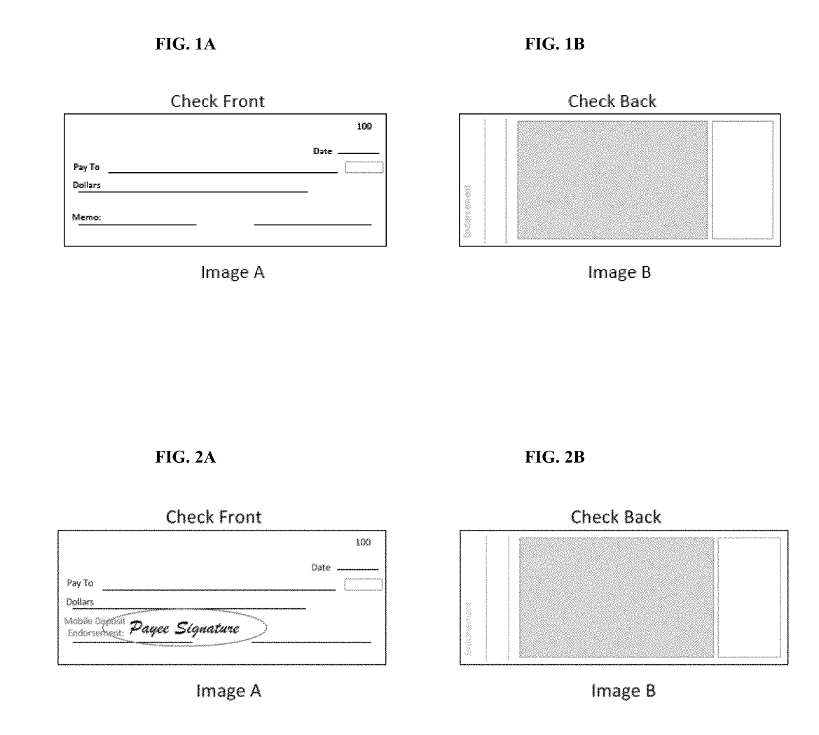

FIG. 1A is a front image of a conventional check. The check front includes a check number (e.g., “100”), a Date field, a Pay To field, an check amount (“Dollars”) field in both text and numerals, a Memo field, and a space for a payor endorsement (signature line).

FIG. 1B is a back image of the conventional check of FIG. 1A. It includes an Endorsement region and other areas which may be used by the depositor financial institution. One or more payee endorsements are typically found in this region. Bank acceptance of conventional checks for deposit are typically done via brick and mortar banking institutions, remote ATM devices, duplex scanning, flatbed scanning and most recently the camera systems of smart phone and tablet devices. The conversion to electronic form for mobile remote deposit using flat bed scanners and smart phones split the once physical check document into two separate images. The majority of check information is present on the front of a check (Side A). The payee's endorsement on the opposite side of the check is important to know at the point of deposit. Thus, conventional check image processes involve two images. This two-image process makes it difficult to assure that the endorsement on the back side of the check (Image B) is the counterpart image to Side A of the check during the conversion of a paper check to an electronic version of the check.

FIG. 2A is a front image of a negotiable instrument according to one embodiment of the present subject matter. In various embodiments, the front image of the present negotiable instrument includes a field for a payee endorsement, a check number (e.g., “100”), a Date field, a Pay To field, an check amount (“Dollars”) field in both text and numerals, a Memo field, and a space for a payor endorsement (signature line). The field for a payee endorsement allows for scanning of the negotiable instrument with a mobile device, such as a mobile phone, portable POS device, portable scanner, or portable camera device. Therefore, in mobile applications this payor endorsement field is also called a “mobile deposit endorsement” because it allows for mobile devices to verify the payee endorsement of the negotiable instrument (e.g., the check) when the front of the document is imaged. The position of the mobile deposit endorsement may vary; however, preferably the mobile deposit endorsement is provided so as to allow standard check information to be positioned and read according to existing standards.

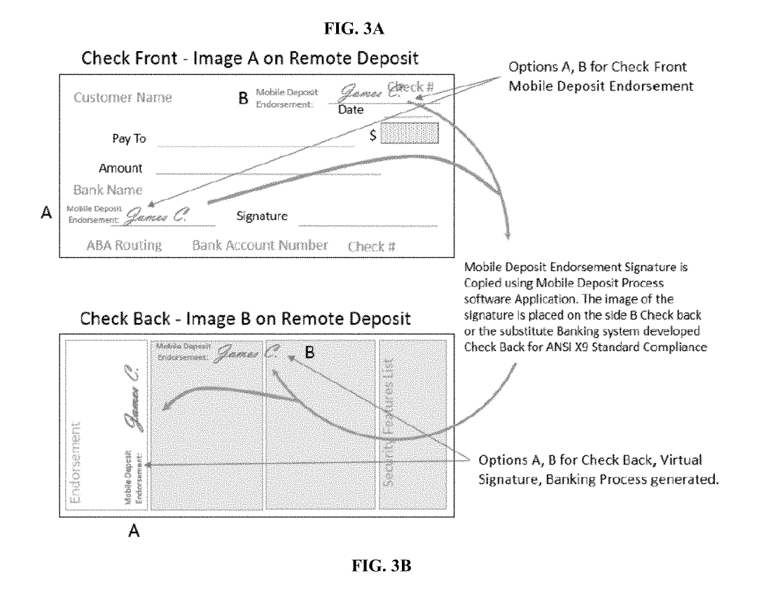

FIG. 3A is a front image of a negotiable instrument according to various embodiments of the present subject matter. FIG. 3A shows mobile deposit endorsements at various positions A and B; however, it is understood that different positions may be employed without departing from the scope of the present subject matter.

FIG. 2B is a back image of a negotiable instrument according to the embodiment of FIG. 2A. In this embodiment, the Endorsement field may remain blank for negotiable instruments having a mobile deposit endorsement on the front side of the negotiable instrument. In contrast, FIG. 3B is a back image of a negotiable instrument according to an embodiment of the present subject matter where the signature from the mobile deposit endorsement is replicated on the back side of the negotiable instrument. FIG. 3B demonstrates two positions where that endorsement may be placed; however, it is understood that other placements may occur without departing from the scope of the present subject matter. In various embodiments, the replicated signature is specially marked to note that the original endorsement appears on the reverse side of the negotiable instrument and that this back side endorsement is copied from the field on the front side of the negotiable instrument. For example, it is understood that the mobile deposit endorsements on the front of the check may be replicated on the back side of the check to allow for processing of the check with legacy check processing methods (using both the back and front side of the negotiable instrument), such as for bank check deposits according to ANSI X9. In cases where the mobile deposit endorsement is found on the front and back side of a negotiable instrument, the negotiable instrument can be processed by legacy check processing methods that use both front and back of the negotiable instrument, and the method of the present subject matter that is capable of processing a single image with the mobile deposit endorsement on it. Thus, check processing on a single front side and check processing on both front and back sides may be performed on a check with endorsements on both sides. Accordingly, in such embodiments, the process of the present subject matter can be used to read the formats of the novel negotiable instruments of the present subject matter and conventionally formatted negotiable instruments.

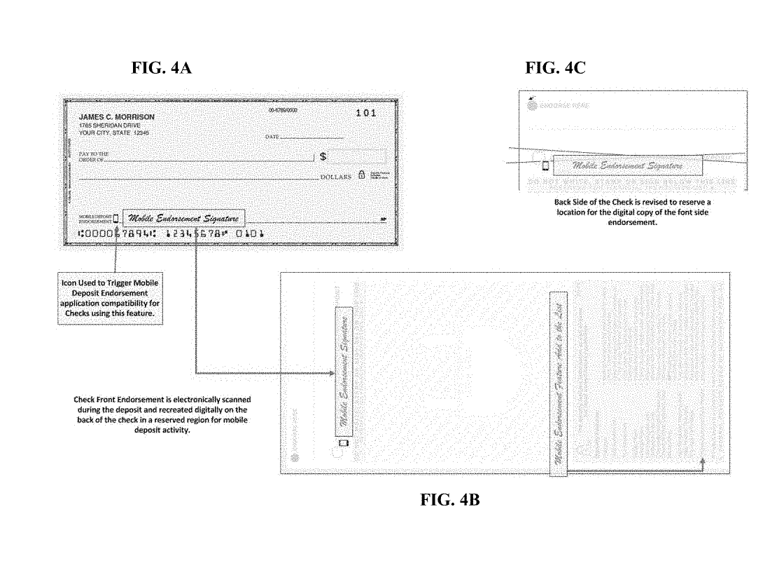

FIG. 4A is a front image of a check including a mobile endorsement signature according to one embodiment of the present subject matter. The payee endorsement on the front of the check is electronically scanned during the deposit of the check and replicated digitally on the back of the check in a reserved region of mobile deposit activity, as shown in FIG. 4B. In various embodiments, such as shown in FIG. 4C, the back side of the check is revised to reserve a region dedicated to provide a location for the digital copy of the mobile deposit endorsement copied from the front side of the check. This approach reserves a location on the back of the check for the digital copy of the front-side endorsement. In such cases, an icon or other special position indicator on the reverse side may be used. In embodiments where the location of the endorsement is reserved on the reverse side of the check a scanning device would be able to find the replicated endorsement and in such embodiments special icons or codes to denote the endorsement are optional.

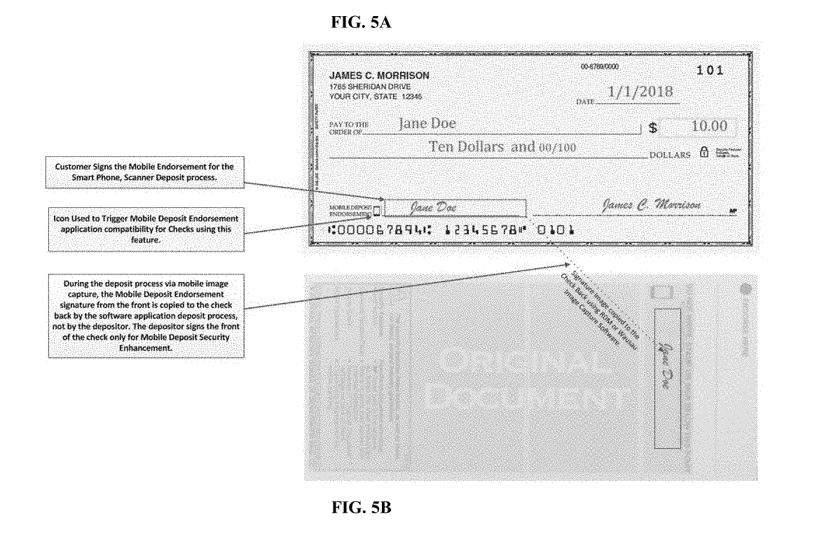

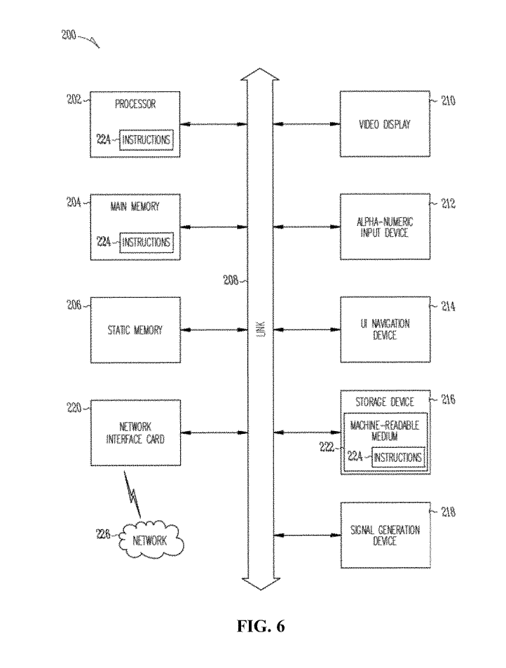

FIG. 5A is a front image of a check including a mobile endorsement icon and signature according to one embodiment of the present subject matter. In various embodiments, the icon is used to trigger a mobile deposit endorsement application which receives a customer signature for the mobile deposit endorsement. In various embodiments, the signature from the front may be copied to the check back by the software application deposit process, as shown in FIG. 5B. In such embodiments, the depositor need only sign the check front, and the software provides both front and back images of the endorsement, making mobile deposits easier and more reliable.

In various embodiments, the present subject matter includes a method for taking a front image of a negotiable instrument, such as a check, having a front-side endorsement region whereby the payee has provided a signature to endorse the negotiable instrument. In various embodiments, the present subject matter includes a method of taking a front image of a negotiable instrument, such as a check, and electronically applying a signature of the payee to the image to endorse the negotiable instrument. Such signature may be obtained by the payee tracing her signature on a touchpad, or by any means to capture the signature. In various embodiments, the present subject matter includes a method of taking a front image of a negotiable instrument, such as a check, and electronically applying an electronic signature of the payee to the image to endorse the negotiable instrument.

In various embodiments, the present subject matter allows a negotiable instrument, such as a check, endorsed on a front image to be deposited with a financial institution, such as a bank, by transmission of the image to the financial institution. In various embodiments a single (front) image bearing a payee endorsement is transmitted to facilitate a deposit. In various embodiments a front image bearing a payee endorsement is transmitted to facilitate a deposit, among other images.

In various embodiments a payee endorsement from a front side of a negotiable instrument, such as a check, is replicated on an image of the reverse side of the negotiable instrument. In various embodiments a payee endorsement from an image of a reverse side of a negotiable instrument, such as a check, is replicated on an image of the front side of the negotiable instrument. In embodiments bearing an endorsement on a reverse side of the negotiable instrument, such as a check, legacy check processing methods may be employed. In embodiments bearing an endorsement on the front side and reverse side of a negotiable instrument, such as a check, a single image processing of the negotiable instrument or a dual-image processing of the negotiable instrument can be performed.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 6 is a block diagram illustrating a machine in the example form of a computer system 200, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments. In various embodiments, it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computer system 200 may further include a video display unit 210, an alphanumeric input device 212 (e.g., a keyboard), and a user interface (UI) navigation device 214 (e.g., a mouse). In one embodiment, the video display unit 210, input device 212 and UI navigation device 214 are incorporated into a touch screen display. The computer system 200 may additionally include a storage device 216 (e.g., a drive unit), a signal generation device 218 (e.g., a speaker), a network interface device 220, and one or more sensors (not shown), such as a global positioning system (GPS) sensor, compass, accelerometer, or other sensor.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computer system 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 224 may further be transmitted or received over a communications network 226 using a transmission medium via the network interface device 220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Examples

The following examples illustrate some of the various embodiments of the present subject matter. Method and apparatus examples are provided which allow for processing a negotiable instrument, comprising: imaging a negotiable instrument including a field for a mobile deposit endorsement, payee information, payment amount, and payor endorsement in one image; and sending the image to a remote destination for processing a payment. Such examples may include prompting a payee to provide a signature for the mobile deposit endorsement. Some examples include where the mobile deposit endorsement is identified using an icon. In some examples, the system will replicate the signature on a second image associated with a back side of the negotiable instrument. In some examples, the signature for the mobile deposit endorsement is positioned on the negotiable instrument such that the payee information, payment amount, and payor endorsement may be processed by conventional check processing applications. In some examples, the system sends the second image to the destination, which includes a financial institution. The system has examples where it will perform imaging a back side of a negotiable instrument.

In various examples, the system provides method for processing a negotiable instrument, comprising: imaging a negotiable instrument bearing a mobile deposit endorsement, payee information, payment amount, and payor endorsement in one image; prompting for a signature for the mobile deposit endorsement; and sending the image to a financial institution for payment of the payment amount to the payee. In various examples the system tags the mobile deposit endorsement using an icon. In some examples the system will replicate the signature on a second image associated with a back side of the negotiable instrument. Some examples include positioning the mobile deposit endorsement on the negotiable instrument such that the payee information, payment amount, and payor endorsement may be processed by conventional check processing applications. Some examples further include replicating the signature on a second image associated with a back side of the negotiable instrument. In various examples, the system will send the second image to the financial institution. In various examples, the mobile deposit endorsement is identified using an icon.

Additional examples include computer readable media configured for an imaging device for processing a negotiable instrument, the computer readable media including instructions for performing the steps comprising: using the imaging device to capture at least one image of a negotiable instrument bearing a mobile deposit endorsement, payee information, payment amount, and payor endorsement in one image; prompting for a signature for the mobile deposit endorsement; and processing the image for transmission to a remote destination. In some examples, the computer readable media further comprising instructions for performing positioning the mobile deposit endorsement on the negotiable instrument such that the payee information, payment amount, and payor endorsement may be processed by conventional check processing applications.

In some examples the subject matter of the claim works on a mobile computing device. In some examples the mobile computing device is a mobile phone.

The present subject matter includes various advantages for various embodiments, including one or combinations of the following advantages. One of the advantages of the use of a mobile deposit endorsement on the front side of a negotiable instrument is that front and back images are no longer needed to process a negotiable instrument. Another advantage of various embodiments of the present subject matter is that there is no need to associate and/or verify front and back images. Another advantage of the present subject matter is that a single side can be scanned, which speeds up check processing of numbers of checks. Another advantage is that storage of a single image is simpler, faster, and requires less memory than a two image process. Another advantage is that storage of a single image requires less storing cost to store information than a two image process. Another advantage is that single sided scanners and photographic apparatus and methods may be employed. Another advantage is that a mobile phone, tablet, flatbed scanner or other imaging apparatus can be used to scan, endorse, and deposit a negotiable instrument by the payee. Another advantage is that an endorsement on a check front can be used as forensic identification. Another advantage is that an endorsement on the check front can be replicated to allow the negotiable instrument to be processed by legacy processing systems and methods. Another advantage is that the authenticity of a check image can be enhanced for single image negotiable instrument processing methods. Another advantage is that the present subject matter allows for more efficient multiple check mobile/remote deposit processes. Other advantages exist which are not described herein.

It is understood that other combinations and configurations may be employed without departing from the scope of the present subject matter. This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A method for processing a negotiable instrument, comprising:
imaging a negotiable instrument including a field for a mobile deposit endorsement, payee information, payment amount, and payor endorsement in one image; and
sending the image to a remote destination for processing a payment.

2. The method of claim 1, further comprising prompting a payee to provide a signature for the mobile deposit endorsement.

3. The method of claim 1, wherein the mobile deposit endorsement is identified using an icon.

4. The method of claim 2, further comprising replicating the signature on a second image associated with a back side of the negotiable instrument.

5. The method of claim 1, further comprising prompting for a signature for the mobile deposit endorsement that is positioned on the negotiable instrument such that the payee information, payment amount, and payor endorsement may be processed by conventional check processing applications.

6. The method of claim 5, further comprising replicating the signature on a second image associated with a back side of the negotiable instrument.

7. The method of claim 4, comprising sending the second image to the destination, which includes a financial institution.

8. The method of claim 6, comprising sending the second image to the destination, which includes a financial institution.

9. The method of claim 1, further comprising imaging a back side of a negotiable instrument.

10. The method of claim 9, comprising sending the back side to a financial institution.

11. A method for processing a negotiable instrument, comprising:
imaging a negotiable instrument bearing a mobile deposit endorsement, payee information, payment amount, and payor endorsement in one image;
prompting for a signature for the mobile deposit endorsement; and
sending the image to a financial institution for payment of the payment amount to the payee.

12. The method of claim 11, further comprising tagging the mobile deposit endorsement using an icon.

13. The method of claim 11, further comprising replicating the signature on a second image associated with a back side of the negotiable instrument.

14. The method of claim 11, further comprising positioning the mobile deposit endorsement on the negotiable instrument such that the payee information, payment amount, and payor endorsement may be processed by conventional check processing applications.

15. The method of claim 14, further comprising replicating the signature on a second image associated with a back side of the negotiable instrument.

16. The method of claim 13, comprising sending the second image to the financial institution.

17. The method of claim 15, comprising sending the second image to the financial institution.

18. The method of claim 14, wherein the mobile deposit endorsement is identified using an icon.

19. Computer readable media configured for an imaging device for processing a negotiable instrument, the computer readable media including instructions for performing the steps comprising:
using the imaging device to capture at least one image of a negotiable instrument bearing a mobile deposit endorsement, payee information, payment amount, and payor endorsement in one image;
prompting for a signature for the mobile deposit endorsement; and
processing the image for transmission to a remote destination.

20. The computer readable media of claim 19, further comprising instructions for performing positioning the mobile deposit endorsement on the negotiable instrument such that the payee information, payment amount, and payor endorsement may be processed by conventional check processing applications.

21. The computer readable media of claim 19, wherein the instructions are for a mobile telephone and the imaging device is a mobile telephone.
